(19) United States
(12) Patent Application Publication
(10) Pub. No.: US 2014/0344713 A1
(43) Pub. Date: Nov. 20, 2014

(54) PERSONALIZATION OF A MESSAGE INTERFACE

(71) Applicant: STREAMWIDE, Paris (FR)

(72) Inventor: Pascal BEGLIN, Paris (FR)

(73) Assignee: STREAMWIDE, Paris (FR)

(21) Appl. No.: 14/277,267

(22) Filed: May 14, 2014

(30) Foreign Application Priority Data
May 16, 2013 (FR) 13 54415

(51) Int. Cl. G06Q 10/10

(52) U.S. Cl. CPC G06Q 10/107
USPC 715/752

(57) ABSTRACT

The invention proposes the management of a graphical user interface for a messaging application on a terminal receiving a message from a first user (A), according to the following steps:
a) selection by the first user of graphical user interface elements,
b) sending (S4) to the recipient terminal (TERB) at least one information item concerning the selected interface elements, and
c) upon receipt (S7) of a message from the first user on the recipient terminal, displaying the message with said interface elements.

The present invention relates to dynamic personalization of a graphical user interface, especially but not exclusively in the field of instant messaging (“chat”).

User interface personalization is an important element in the attractiveness of all types of applications (software applications on a personal computer, web interfaces, client applications on mobile phones, etc.).

All these interfaces can be personalized by users via sets of parameters that the user can change.

For example, the Microsoft Word application allows customizing its interface using the “Word Options” menu. Similarly, Google's customizable web interface “iGoogle” allows personalizing page content by selecting items (gadgets) from a list and choosing the type of information the user wants to see, or by changing the theme of the interface. In the latter case, the user can choose coordinated themes or can import content elements he or she has created (such as photos). These themes are also called “skins”, and this type of personalization is known as “skinning”. It allows the interface to “change skins”.

Some forms of personalization are “pushed” (imposed in “push” mode) by the interface publisher. Examples are advertising spaces in mobile applications or web pages. This personalization is based on targeted ads using information collected about the user by the publisher.

However, in these known interface personalization techniques, the only parties able to impose a form of interface are limited to:
its direct user (referred to as “entity B” below), and/or
its publisher.

The present invention improves this situation.

It proposes a method for managing a graphical user interface of a messaging application on a terminal receiving a message from a first user, said method comprising the steps of:
a) selection by the first user of graphical user interface elements,
b) sending to the recipient terminal at least one information item concerning the selected interface elements, and
c) upon receipt of a message from the first user on the recipient terminal, displaying the message with said interface elements.

Thus, the invention allows others to personalize the graphical user interface of the terminal receiving a message (entity B). People (message senders) interacting with entity B through the interface can, within this interaction, dynamically personalize the interface of entity B to reflect their own personality, their interests, and/or to enable immediate identification.

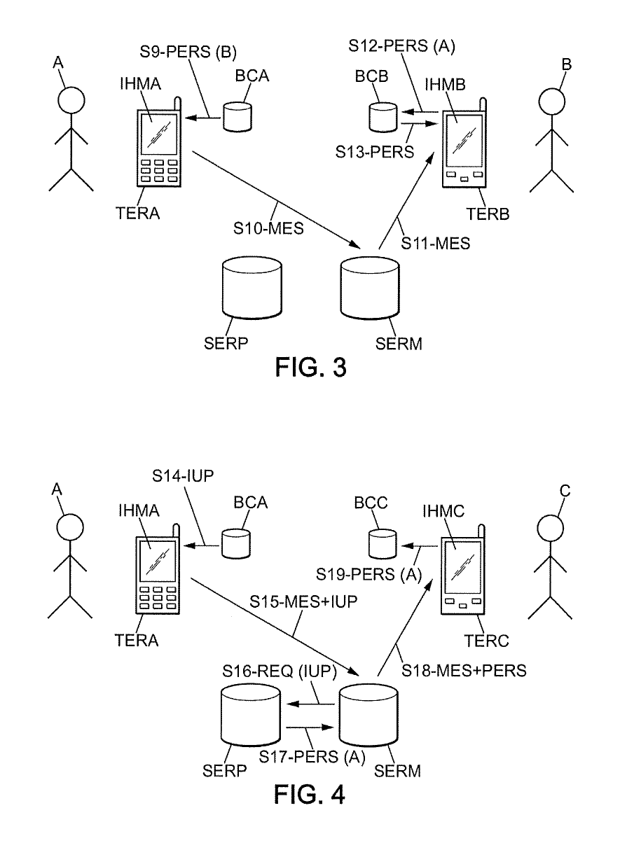

The term “information item concerning the selected interface elements” is understood to mean:
the interface elements themselves, as will be seen in an exemplary embodiment described below with reference to FIG. 2, or
a unique personalization identifier which allows retrieving these interface elements from a dedicated server, as will be seen in an exemplary embodiment described below with reference to FIG. 4, or
a simple contact information item for said first user (the user who sent the initial message), if the recipient terminal has already stored said interface elements, as will be seen in an exemplary embodiment described below with reference to FIG. 3.

The term “interface elements” is understood to mean at least one of the following:
a color for displaying the message characters,
a font for displaying the message characters,
a background color for displaying the message,
one or more multimedia content items (for example forming advertising, etc.),
one or more multimedia content items specific to the first user (for example personal content).

Of course, the method may comprise a step in which a user of the recipient terminal can confirm whether or not the aforementioned interface elements are to be applied when displaying the message from the first user, for example via a graphical user interface of the recipient terminal.

In one embodiment, a first implementation of step b) above comprises:

b1) an operation of sending interface elements, for the storage of said interface elements in correspondence with at least one identifier.

In one particular embodiment, the interface elements sent in operation b1) are received by the recipient terminal with a message from the first user, and the interface elements are stored on the recipient terminal in correspondence with at least one identifier for the first user which is contained in said message.

For example, the identifier for the first user can be an identifier of a contact database, that is stored on the recipient terminal.

In this embodiment, upon receipt of subsequent messages containing the identifier for the first user, after operation b1), the recipient terminal can retrieve the stored interface elements based on the identifier for the first user that is contained in the subsequent messages, and can display these subsequent messages using the previously stored interface elements.

The interface elements may additionally be stored on the terminal of the first user in correspondence with at least one identifier of the user of the recipient terminal, and thus, for subsequent messages sent to the recipient terminal, the terminal of the first user can send these subsequent messages without having to send interface elements or a corresponding identifier.

Additionally or alternatively to the specific embodiment above, the interface elements sent in operation b1) may be stored on a server in correspondence with at least one identifier.

In this embodiment, said server may be an interface element personalization server and the identifier may be a unique personalization identifier specific to a given form of interface.

In an embodiment where a messaging server is provided for relaying messages between the first user and one or more recipients of these messages, the method may then include the following steps:
upon receipt of a given message from the first user, with a unique personalization identifier, the messaging server forwards this unique personalization identifier to the personalization server,
next, the personalization server can retrieve the interface elements based on the unique personalization identifier and can send these interface elements to the messaging server,
the messaging server then sends the interface elements with said given message to its recipient or recipients.

Step a) may comprise a communication operation between a terminal available to the first user and an interface element personalization server, proposing a choice of interface elements among a plurality of possible interface elements, the elements ultimately selected being stored possibly in correspondence with at least one identifier (on the personalization server with a unique personalization identifier and/or on the terminal of the first user, possibly but not necessarily in correspondence with one or more identifiers for the recipients of future messages from the first user).

The method according to the invention has advantageous applications in instant messaging, but is not limited to such applications.

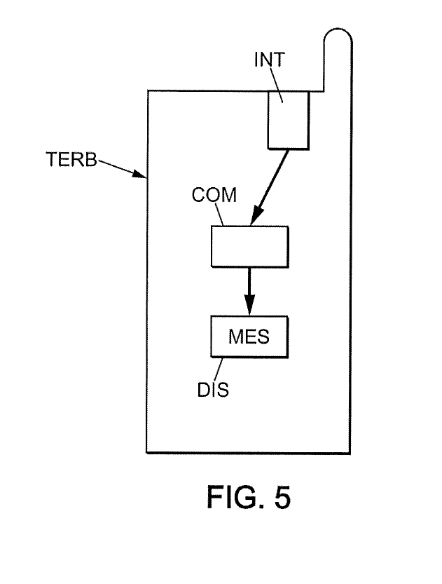

The present invention also relates to a terminal (typically the recipient terminal on which the interface personalization is applied). Such a terminal is arranged to execute a messaging application, and comprises means for managing a graphical user interface for this messaging application. In particular, with reference to FIG. 5, said management means of the terminal TERB comprise:
an interface INT for receiving graphical user interface elements selected by a remote user, and
control means COM for the display DIS of a message MES received from this remote user, using said interface elements.

The present invention also relates to a computer program comprising instructions for implementing the above method, when this program is executed by a processor. The program may include instructions stored by the recipient terminal for execution, as well as instructions distributed between the interface personalization server and the terminal of the first user, in particular to allow them to interact.

Other features and advantages of the invention will be apparent from reading the following detailed description, given by way of non-limiting example, and by considering the drawings in which:

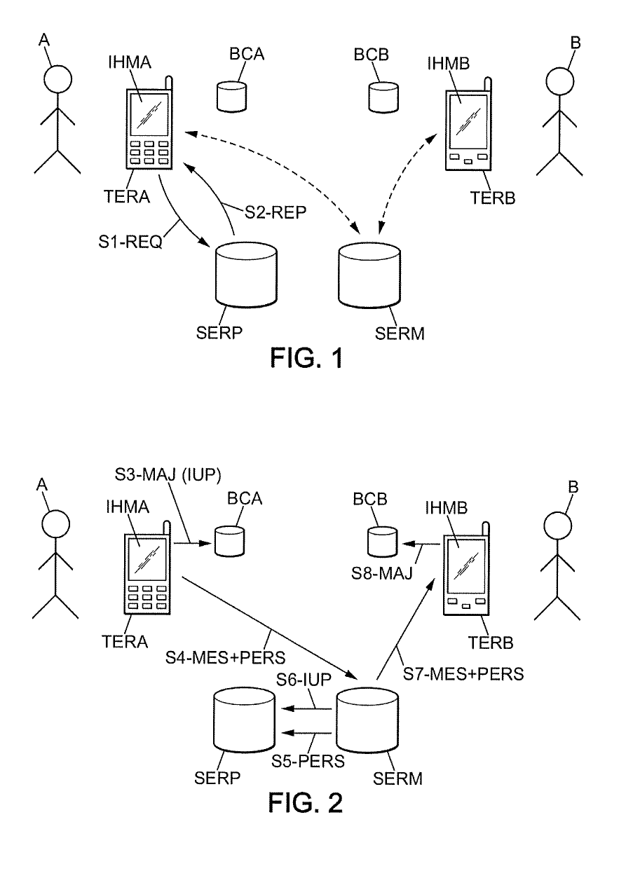

FIG. 1 illustrates an exemplary embodiment of the method according to the invention in a system adapted to implement the method, in particular for carrying out a first step of personalization by a user A of an interface of a terminal of a user B,

FIG. 2 illustrates an exemplary embodiment of the method according to the invention, in the above system, in particular for carrying out a second step of sending a message whose content is displayed using the abovementioned personalization on the terminal of user B,

FIG. 3 illustrates an exemplary embodiment of the method according to the invention, in the above system, in particular for carrying out a subsequent step of sending a message whose content is displayed using a personalization previously saved on the terminal of user B,

FIG. 4 illustrates an exemplary embodiment of the method according to the invention, in the above system, in particular for carrying out a step of sending a message whose content is displayed using a personalization not yet saved on the terminal of a third user C, and

FIG. 5 schematically illustrates the means of a recipient terminal TERB in the sense of the invention.

The invention applies advantageously but in a non-limiting manner to the case of messaging software. When exchanging messages, user A may wish to personalize the interface of the terminal of user B (entity B above) to better reflect his current mood or personality to user B. This personalization may include a change of wallpaper, a specific message font, a change in the layout of commands on the screen, and/or highlighting certain commands to facilitate giving the specific responses requested.

This personalization allows changing all or part of the interface, in particular changing a specific part or spreading the changes across various sections of the interface.

This personalization can be initiated by an individual, or by the result of an algorithm that takes into account, for example, proposed personalizations exchanged through a messaging system by all subscribers or by a subset specific to user B (personalizations received from his contacts, last received personalizations, etc.). The resulting personalization may be a combination of personalizations initiated by an individual for one part of the interface, and by an algorithm for another part. A direct application of this last possibility allows user B to know dynamically the most common areas of interests he shares with the contacts he communicates with most often.

The invention thus allows user A to “push” interface personalization elements to his contacts (for example a user B) within the messages he exchanges with them. This enriches communications with his contacts and expresses his personality and current areas of interest, while communicating the content of his message. User A is thus better identified to user B, by distinctive signs that reflect his current mood, or more usually his “brand.” The user can thus be associated with a group, an individual, or a trademark that best represents his interests.

The interface personalization elements that user A chooses for the interface for user B include, but are not limited to:
wallpapers,
colors for sections of the interface,
shapes, or fonts, or characters appearing within “bubbles” in the context of conversations by electronic messaging,
images or videos accessible in the conversation (in the messages exchanged) or in a specific location in the interface of user B (accessible via a menu in the interface, for example)
web links to content available online, in the messages exchanged or, again, in a specific location in the interface of user B,
changes to the appearance of the interface of user B to facilitate the nature of the desired response, the action to be taken by user B, or to highlight content items marked by user A as being part of the personalization,
an interface element of user B (button, field, or other element) that allows user B to instantly adopt the personalization proposed by user A.

These personalization elements can be grouped (in JAVA for example) to form a communicated set. These sets can be created by user A on his terminal or can be proposed by the interface of his terminal. Advantageously, an algorithm can be used to propose personalization elements that best correspond to the interests of user A, identified by the topics of his message exchanges and/or by his choices when browsing the web for example.

By way of non-limiting example, several tabs may be proposed for example in an interface of the terminal of user A, allowing him to choose between several possible interface elements for displaying messages on the terminal of user B, this choice possibly being made at the discretion of user A (according to his mood, his current interests, etc.). For example, the interface elements may include a specific advertising theme (for example, a sports team or a group of musicians, a brand of clothing, or any brand).

The invention then allows user B to receive these personalizations and dynamically adapts his messaging interface to express the personality or interests of the people using messaging in general and of his circle of contacts in particular. It allows user B to easily identify the party sending the message, to associate him or her with a group of individuals, a personality, an artist, a trademark, a hobby, and more generally with a current interest. It can allow user B to find out the most common interests shared by his close friends or by subscribers who are in the same geographical area, who are the same age, who attend the same school, etc.

Referring now to the figures, in the context of an instant messaging service on mobile phones used here by way of example, user A has a terminal TERA (for example a mobile phone terminal, for example a smartphone, or a computer tablet, computer, etc.) connected to a telecommunications network and programmed to execute a graphical user interface IHMA in the context of an instant messaging application (“chat”). Similarly, user B has a terminal TERB, also connected, and programmed to execute a graphical user interface IHMB in the context of said instant messaging application. Communication between the terminals TERA and TERB is provided by the messaging server SERM (dotted two-way arrows in FIG. 1), via said telecommunications network (not shown).

As a preliminary, the first step of the method consists of user A initially selecting the interface personalization IHMB he wants to push to user B.

For this purpose, in one particular embodiment the interface IHMA of terminal TERA of user A proposes to user A that he personalize the interface of the terminals of people to whom future messages from user A are to be sent, or to modify this interface if user A has already previously adopted a personalization.

If user A confirms, via a messaging application that runs on his terminal TERA, that he wishes to personalize the interfaces of his message recipients, the messaging program installed on terminal TERA causes terminal TERA to query a personalization server SERP that is able to propose interface personalizations (arrow S1-REQ in FIG. 1). This personalization server can be the same entity as the messaging server SERM or a separate entity.

Following this request S1-REQ sent by terminal TERA to server SERM, server SERM responds (arrow S2-REP in FIG. 1) by sending proposed personalizations to terminal TERA (for example sending text in different colors and fonts and on different background colors) so that user A can then choose one of the proposed forms of interface or a combination of the proposed forms.

Thus, user A can select a personalization from a set of predetermined personalizations, or can develop one himself, for example by combining characteristics of predetermined interfaces. A unique personalization identifier (referred to below as IUP) then associates, in a one-to-one correspondence, the results of the personalization and the form of the interface that is subsequently installed on the terminals of the users receiving messages from user A. This identifier IUP is:
defined by server SERP, if user A adopts a predetermined personalization,
or defined by the messaging application that runs on terminal TERA if user A develops his own personalization.

In the next step, now referring to the exemplary embodiment in FIG. 2, user A sends a message MES to user B, this message being associated with the selected personalization.

For this purpose, the messaging application updates the contact database BCA of user A on his terminal TERA (arrow S3-MAJ(IUP) in FIG. 2), with the identifier IUP defining the forms of interfaces for the terminals of the contacts of user A in the messaging application.

Then, when the first message is sent after personalization (arrow S4-MES+PERS in FIG. 2), the message frame contains the associated personalization elements in a data segment (or “compartment”) that is identified to avoid confusion with the actual message content. The identifier IUP is also communicated in the message frame. The personalization elements and the identifier IUP may alternatively be sent in a specific service message, which is sent in parallel with the message MES.

The messaging server SERM can then:
forward the message (with the personalization information) as is, to the terminal TERB of user B, or
extract the personalization information and send it to the personalization server SERP (arrow S5-PERS in FIG. 2).

The personalization server SERP can then store this personalization information according to the identifier IUP sent to it by the messaging server SERM (arrow S6-IUP in FIG. 2). Thus, for future uses of the messaging service that involve user A, possibly with other recipients than user B, the terminal of user A only needs to send the identifier IUP. The personalization server SERP, using the identifier IUP, finds the personalized interface elements selected by user A in order to send these characteristics to the recipients of messages from user A, as will be seen below in the embodiment illustrated in FIG. 4.

Referring again to FIG. 2, server SERM sends to the terminal of user B the message that it receives from user A (arrow S7-MES+PERS in FIG. 2). Thus, when terminal TERB of user B receives from server SERM the message from user

A, it displays the message for user B, and stores in its contact database BCB the personalization information sent by the terminal of user A (arrow S8-MAJ in FIG. 2), in correspondence with the contact information of user A and possibly the identifier IUP. User B can choose beforehand whether to allow user A to personalize his interface when communicating with user A. If user B has accepted the personalizations from user A, the local contact database BCB of the messaging application of user B is updated, in particular in order to associate with user A his content personalizations and possibly the identifier IUP, the content personalizations being stored on the telephone of user B.

It may be advantageous to store the personalization elements on terminal B as a function of an identifier IUP, even though they are associated with one user A. Depending on his current mood or on the timestamp of the current message, user A may prefer displaying his message with a different form of interface (for example a whimsical interface for messages received after 8 p.m. and during weekends, and a more conventional interface during office hours). It is therefore understood that multiple identifiers IUP can be associated with one user A.

Referring again to FIG. 2, when user A receives an acknowledgment of the message sent to user B, he can confirm that his own contact database BCA is updated to indicate that user B has received the current personalization (arrow S3-MAJ(IUP) in FIG. 2). User A then no longer needs to send the personalization content to user B along with his messages, as long as his personalization remains unchanged.

Referring now to FIG. 3, user A sends a new message to user B, without modifying the personalization data. In particular, here user A sends another message to user B without having changed his personalization. The messaging application that runs on terminal TERA of user A then queries the contact database BCA (arrow S9-PERS(B) in FIG. 3) and obtains the information that the current personalization has already been communicated to user B. Terminal TERA therefore does not send the personalization information with the content of the message sent to server SERM (arrow S10-MES in FIG. 3). The messaging server SERM sends the message (arrow S11-MES in FIG. 3) to terminal TERB. The latter, on receiving this message, queries its contact database BCB (arrow S12-PERS(A) in FIG. 3) and thus determines that messages from user A have a personalization stored on terminal TERB (arrow S13-PERS in FIG. 3). Terminal TERB modifies the graphical user interface of the messaging application accordingly.

In the context of FIG. 4, user A sends a message to user C for the first time since the last personalization was made by user A. In particular, if user A sends a message to another user C when his personalization has not been sent to user C beforehand, the embodiment represented in FIG. 2 can be implemented. However, to avoid having to transmit interface elements that may be resource-heavy (images, videos, etc.), it is preferable to make use of the personalization server SERP. If user A sends a message to user C and this message is not the first message sent since the current personalization of user A took effect, terminal TERA sends the message (arrow S15-MES+IUP in FIG. 4) with no personalization elements but with the identifier IUP fetched from the contact database BCA (arrow S14-IUP in FIG. 4) where it had been previously stored (arrow S3-MAJ(IUP) in FIG. 2). The messaging server detects the identifier IUP and sends a request to the personalization server SERP (arrow S16-REQ(IUP) in FIG. 4) to retrieve the corresponding personalization elements (arrow S17-PERS(A) in FIG. 4). The messaging server SERM aggregates the retrieved personalization elements with the message sent to terminal TERC of user C (arrow S18-MES+PERS in FIG. 4). The interface IHMC of terminal TERC then displays the message using the personalization of user A. The latter can then decide whether to accept storing the personalization elements of user A in the contact database BCC on his terminal TERC, in order to apply such personalization in subsequent messaging sessions with user A (arrow S19-PERS(A)), as described above in reference to FIG. 2.

Thus, in general, the terminal of user B (or of user C in the embodiment in FIG. 4) contains, in its local database, the personalization information for his contacts. These are updated dynamically when the sender sends a message to user B after changing his or her personalization. This local database therefore provides a good sample of the current areas of interest among the network of contacts of user B. A specific page in the graphical user interface can present this data in aggregate form. A suitable algorithm can filter this local information and present it in an order that best illustrates for user B the interests of his network of contacts. This algorithm can be based, for example, on statistical information about the personalizations adopted by the network of contacts of user B, the number of messages exchanged with each of these contacts, the message timestamp, the geographic location of user B, or profile data collected from user B himself. User B thus sees the key interests of his relations. It is understood that the invention thus allows measuring the “viral” aspect (the speed of propagation) of certain areas of social interest.

Of course, the present invention is not limited to the embodiment described above by way of example; it extends to other variants.

For example, the invention can be applied to all types of terminals, not just mobile terminals.

The invention can also be implemented in the case where the graphical user interface does not reside on a local application but on an Internet-type centralized server with web interfaces for users and with a central database replacing the contact databases of each user.

In addition, the unique personalization identifier referred to above, although advantageous, is optional. In one possible embodiment, based on a sender identifier (contact information for the terminal of user A, for example), generally indicated inside a frame of the message, the messaging server SERM can be adapted to transmit the interface elements (previously stored on it) to any terminal that is a recipient of the message. However, such an embodiment consumes communication resources within a network.

1. Method for managing a graphical user interface of a messaging application on a terminal receiving a message from a first user, said method comprising the steps of:
a) selection by the first user of graphical user interface elements,
b) sending to the recipient terminal at least one information item concerning the selected interface elements, and
c) upon receipt of a message from the first user on the recipient terminal, displaying the message with said interface elements.

2. Method according to claim 1, wherein a first implementation of step b) comprises:
b1) an operation of sending interface elements, for the storage of said interface elements in correspondence with at least one identifier.

3. Method according to claim 2, wherein the interface elements sent in operation b1) are received by the recipient terminal with a message from the first user, and the interface elements are stored on the recipient terminal in correspondence with at least one identifier for the first user which is contained in said message.

4. Method according to claim 3, wherein the identifier for the first user is an identifier of a contact database, that is stored on the recipient terminal.

5. Method according to claim 3, wherein, upon receipt of subsequent messages containing the identifier for the first user, after operation b1), the recipient terminal retrieves the stored interface elements based on the identifier for the first user that is contained in the subsequent messages, and displays said subsequent messages using said interface elements.

6. Method according to claim 3, wherein, the first user having a terminal, the interface elements are additionally stored on the terminal of the first user in correspondence with at least one identifier of the user of the recipient terminal, and, for subsequent messages sent to the recipient terminal, the terminal of the first user sends said messages without any interface elements or corresponding identifier.

7. Method according to claim 2, wherein the interface elements sent in operation b1) are stored on a server in correspondence with at least one identifier.

8. Method according to claim 7, wherein said server is an interface element personalization server and the identifier is a unique personalization identifier.

9. Method according to claim 8, wherein, a messaging server being provided for relaying messages between the first user and one or more recipients of said messages:
upon receipt of a given message from the first user, with a unique personalization identifier, the messaging server forwards said unique personalization identifier to the personalization server,
the personalization server retrieves the interface elements based on the unique personalization identifier and sends the interface elements to the messaging server,
the messaging server sends the interface elements with said given message to said one or more recipients.

10. Method according claim 1, wherein, the first user having a terminal, step a) comprises a communication between the terminal of the first user and an interface element personalization server, the personalization server being able to propose a choice of interface elements among a plurality of elements, the selected interface elements being stored.

11. Method according to claim 10, wherein a first implementation of step b) comprises an operation b1) of sending interface elements, for the storage of said interface elements in correspondence with at least one identifier, the interface elements sent in operation b1) being stored on a server in correspondence with at least one identifier,
wherein said server is an interface element personalization server and the identifier is a unique personalization identifier, and wherein the personalization server stores the selected elements in correspondence with at least one unique personalization identifier.

12. Method according to claim 1, wherein the interface elements comprise at least one of the following:
a color for displaying the message characters,
a font for displaying the message characters,
a background color for displaying the message,
one or more multimedia content items,
one or more multimedia content items specific to the first user.

13. Method according to claim 1, wherein the messaging application is an instant messaging application.

14. Terminal, arranged to execute a messaging application, and comprising means for managing a graphical user interface for said messaging application, said means comprising:
an interface for receiving graphical user interface elements selected by a remote user, and
control means for displaying a message received from the remote user, using said interface elements.

15. Computer program comprising instructions for implementing the method according to claim 1 when this program is executed by processor.
